(19) United States
(12) Patent Application Publication
(10) Pub. No.: US 2021/0382379 A1
(43) Pub. Date: Dec. 9, 2021

(54) MOBILE PROJECTION APPARATUS

(71) Applicants: Alan Lachaumette, Sherman Oaks, CA (US); Damien Phelan Stolarz, Los Angeles, CA (US); Scott Nyberg, Maple Valley, WA (US)

(72) Inventors: Alan Lachaumette, Sherman Oaks, CA (US); Damien Phelan Stolarz, Los Angeles, CA (US); Scott Nyberg, Maple Valley, WA (US)

(21) Appl. No.: 16/891,300

(22) Filed: Jun. 3, 2020

(51) Int. Cl. G03B 21/14; G03B 21/26; B60Q 1/50; G01C 21/36

(52) U.S. Cl. CPC G03B 21/145; G03B 21/26; B60Q 2400/50; B60Q 1/50; G01C 21/365; G03B 21/147

(57) ABSTRACT

A projection apparatus for automobile which is releasably attachable to an exterior portion of an automobile including a projection means, microprocessor; memory module; and housing which enable a selected image to be transmitted over a wireless network to the apparatus and compared with the plurality of stored images is provided. The selected image may be stored for a period of time and displayed through the projection means onto an exterior portion of the automobile for a pre-determined period of time using a timer.

### TECHNICAL FIELD

The embodiments presented provide for a mobile projection apparatus to display images onto a portion of automobile.

### BACKGROUND

The importance of advertising and promotions have taken various shapes and sizes, such as large billboard on the side of major highways or scannable codes that direct a consumer to a website. Vehicle manufacturers, sports teams, and major brands are continuously looking for news way to market and project their logos and trademarks in the public domain.

Vehicle owners and sports fanatics have been customizing their automobile with their favorite sports memorabilia and stickers since the advent of professional and collegiate sports. Fans are willing to paint their vehicles in their “team colors” to show their pride and devotion to their team. Corporations have consistently projected hometown sports colors or images onto building during the playoffs or rivalry.

The use of projections in the commercial and education setting have been used for years, often presenting various educational material through a projection means. However, the use of projectors has spread to the residential settings where holiday decorations and messages may be displayed on the side of home. Despite the known art in the commercial and residential settings, there is no single reference which discloses a portable projector apparatus that mounts onto the exterior or interior of a vehicle and displays selected images stored within a memory module.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

Embodiments described herein provide a mobile projection apparatus configured to project a plurality of images on the exterior portion of an automobile.

In one aspect, the apparatus includes a hermetically sealed housing containing a microprocessor, projection means, and memory module powered by an internal power supply (i.e., battery). The hermetically sealed housing includes at least one securing means, which may be configured about a portion of the automobile and may be used in any weather conditions without water intrusion to the interior components. The microprocessor is wirelessly connected to a network and allows the user to download and save a plurality of images within the internal storage device (i.e., memory module). When selected for use, the selected images stored within the memory module are transmitted to the projection display module where they are displayed through a translucent lens onto the vehicle.

In one aspect, the housing comprises a translucent portion to project the imagery onto an exterior surface of the vehicle.

In one aspect, the housing is releasably engaged to a mounting assembly configured to releasably engage with the interior of the vehicle.

In one aspect, the mounting assembly releasably engages to the vehicle via a first bracket and a second bracket.

In one aspect, the mounting assembly further comprises a pivot to permit the rotation of the projector.

In one aspect, an adjustable projector lens provides at a standard, wide, and ultra-wide-angle projection of the selected image.

In one aspect the projector further includes a plurality of light emitting diodes.

In one aspect, the microprocessor is configured to receive a selected image over a wireless network.

In one aspect, the microprocessor is further configured to transmit a selected image from the memory module to the projector.

In another embodiment, the apparatus includes a housing containing a microprocessor, projection means, and memory module powered by an internal power supply (i.e., battery). The housing integrates with at least one securing means, which may be configured about a fixed element of the automobile such as a seat headrest, a window, a ceiling, door handle, a light fixture, a handlebar, or the like. The microprocessor is wirelessly connected to a network and allows the user to download and save a plurality of images within the internal storage device (i.e., memory module). When selected for use, the selected images stored within the memory module are transmitted to the projection display module where they are displayed on a translucent film attached to a window of the vehicle.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the mobile projection apparatus, according to some embodiments; and

FIG. 2 illustrates a perspective view of the mobile projection apparatus projecting an image onto a window, according to some embodiments; and

FIG. 3 illustrates a perspective view of the mounting assembly, according to some embodiments; and

FIG. 4 illustrates a perspective view of the exterior of a vehicle and a projection on the window of the vehicle, according to some embodiments;

FIG. 5 illustrates a front elevation view of the film positioned on the window of a vehicle, according to some embodiments;

FIG. 6 illustrates a block diagram of the projector system, according to some embodiments;

FIG. 7A illustrates a perspective view of the mounting element for attaching the projector system to a vehicle seat headrest, according to some embodiments;

FIG. 7B illustrates a perspective view of the mounting element for attaching the projector system to a vehicle seat headrest, according to some embodiments;

FIG. 7C illustrates a perspective view of the mounting element for attaching the projector system to a vehicle seat headrest, according to some embodiments;

FIG. 7D illustrates a perspective view of the mounting element for attaching the projector system to a vehicle seat headrest, according to some embodiments;

FIG. 7E illustrates a perspective view of the mounting element for attaching the projector system to a vehicle seat headrest, according to some embodiments;

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements. Upon reading the teachings of this specification, those with ordinary skill in the art will now understand that, under appropriate circumstances, considering such issues as economics, user preference, available designs, advances in technology, etc., other light patterns, designs, logos, etc., such as circles, holograms, animated images, etc., may suffice. Further, upon reading the teachings of this specification, those with ordinary skill in the art will now understand that, under appropriate circumstances, considering such issues as projector preferences, economics, user preference, advances in technology, etc., other projectors, such as those using film to create a decorative projection, etc., may suffice.

The embodiments provide a mobile projection apparatus that may used in a variety of settings by enabling a user to download a plurality of images, logos, or advertisements (collectively “imagery”) from the internet over a wireless network to a microprocessor where they are stored within a memory module and transmitted to the projection module for display. The apparatus further contemplates an integrated timing means that allows the user to pre-select a display duration for the selected images and rotate through the plurality of images stored within the memory module.

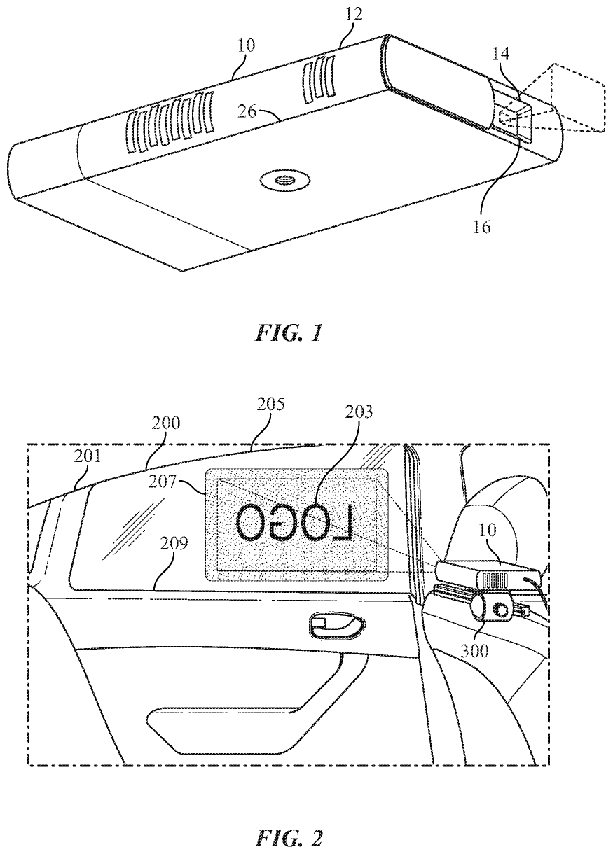

Referring now to the drawings wherein like reference numerals designate identical or corresponding parts throughout the views. There is shown in FIG. 1 a mobile projection apparatus 10 which may releasably attach to the interior or exterior of an automobile. The apparatus 10 is configured to display a plurality of still or animated logos, slogans, trademarks, and advertisement on the exterior body of the vehicle, such as by projecting the image onto at least one window of the vehicle. The apparatus 10 includes a housing 12 have a translucent portion 14 and projecting lens 16. Further, a microprocessor includes an integrated memory module.

In some embodiments, it is contemplated that the housing 12, when placed outside of the vehicle, is comprised of high durometer plastic or thermoplastic casing which is hermetically sealed with both the translucent portion 14 and the lens to prevent moisture intrusion into the interior portion. However any high durometer material or metal may be used as long as it provides a water barrier to the interior components.

In further reference to FIG. 1, the hermetically sealed housing 12 includes a square-shape configuration with substantially cylindrically shaped edges. A top portion of the housing 26 includes at least one aperture to releasably secure a plurality of adjustable straps which enable the user to releasably attach the apparatus 10 to portion of the automobile interior or exterior. Shown in the current and preferred embodiment is the apparatus 10 attached to the rear-view mirror with two straps releasably attaching to the front edge.

In some embodiments, the apparatus 10 may be a pico-projector, or similar portable projection device that can be readily transported and releasably mounted within a vehicle. The apparatus 10 is configured to project bright, high-resolution imagery on the side and/or rear windows of the vehicle.

The vehicle may include automobiles, trucks, airplanes, trains, bicycles, buggies, motorcycles, and other forms of transportation which may benefit from the embodiments described herein.

In some embodiments, the apparatus 10 may be wireless or be provided with a wired power cable connected to a power source, such as the vehicle battery or auxiliary power system. In another embodiment the apparatus 10 is provided with a power source disposed within the housing 12.

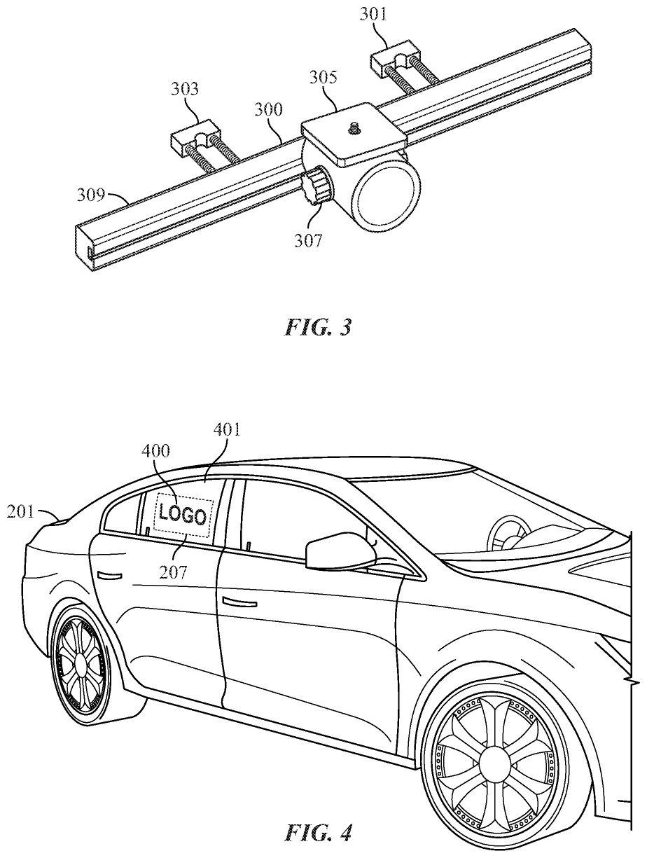

FIG. 2 illustrates a perspective view of the apparatus 10 releasably mounted to an interior surface 200 of a vehicle 201. The apparatus 10 is arranged to project imagery 203 onto the window 205. A film 207 is positioned on the interior side 209 of the window 205. The film provides a uniform surface color and texture to ensure the imagery is suitable displayed when viewed from the exterior of the vehicle 201. A mounting assembly 300 form an interface between the vehicle interior and the projector apparatus 10.

In some embodiments, an adjustment means allows the apparatus 10 to be used with a plurality of rear-view mirror sizes and shapes. In the present configuration, the projection would be visible on the exterior driver side door.

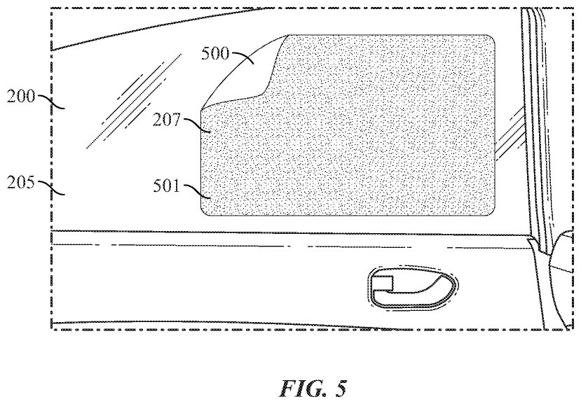

FIG. 3 illustrates the mounting assembly 300 comprising a first bracket 301 and a second bracket 303 to releasably engage the mounting assembly 300 to a surface within the interior of the vehicle. A mount 305 releasably engages with the projector apparatus 10 permitting tilting and rotation of the apparatus 10 via a pivot 307. The mount 305 may sliding engage with a member 309 to permit the movement of the apparatus 10 along the length of the member 309. One skilled in the arts will readily understand that various user preferences, vehicle contours, desired projected design, mounting arrangements, such as extendable/retractable projector mountings, articulated mounts, pop-out panels, etc., may be implemented.

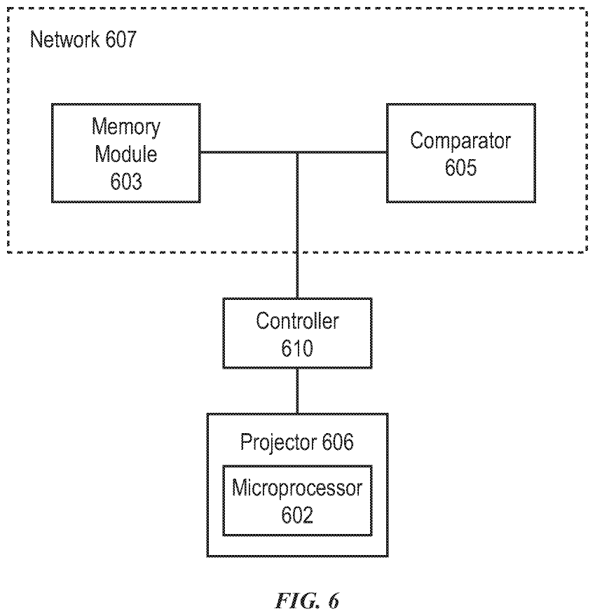

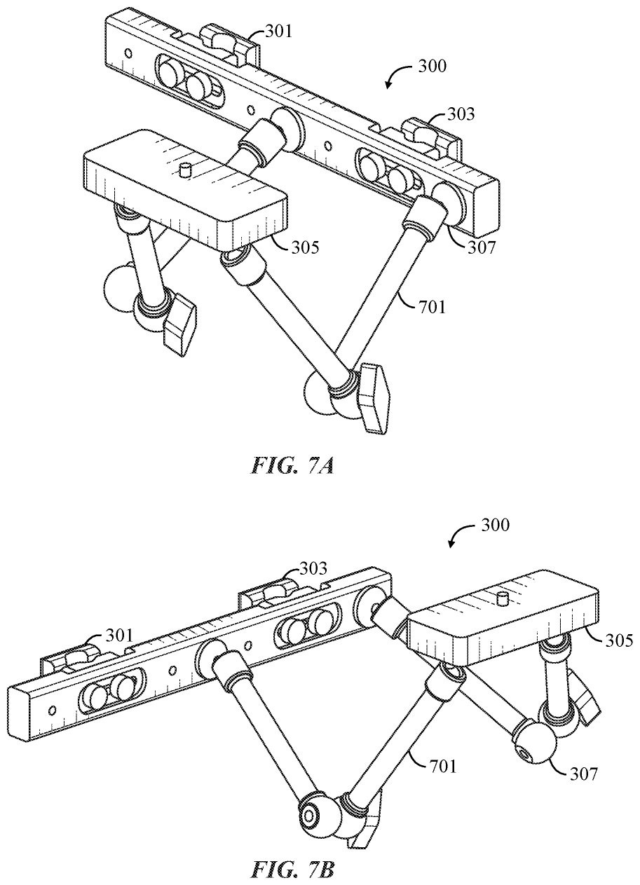

FIG. 4 illustrates the project imagery 400 onto the window surface 401 of the vehicle 201. The projected imagery 400 is sized to fit the surface area of the window and/or the film 207 such that the projected imagery is visible from the exterior of the vehicle. The imagery may include still images, videos, or a series of images presented as a slideshow. The apparatus 10 may be modified via an adjustable lens to alter the size of projected image to fit varying sizes of the projection surface. FIG. 5 illustrates the film 207 adhered to the interior surface 200 of the window 205. The film 207 is comprised of a first side 500 and a second side 501. The first side 500 is coated with an adhesive to retain the film 207 on the interior surface 200 of the window. The second side 501 is comprised of a colored and textured surface optimize the projected image.

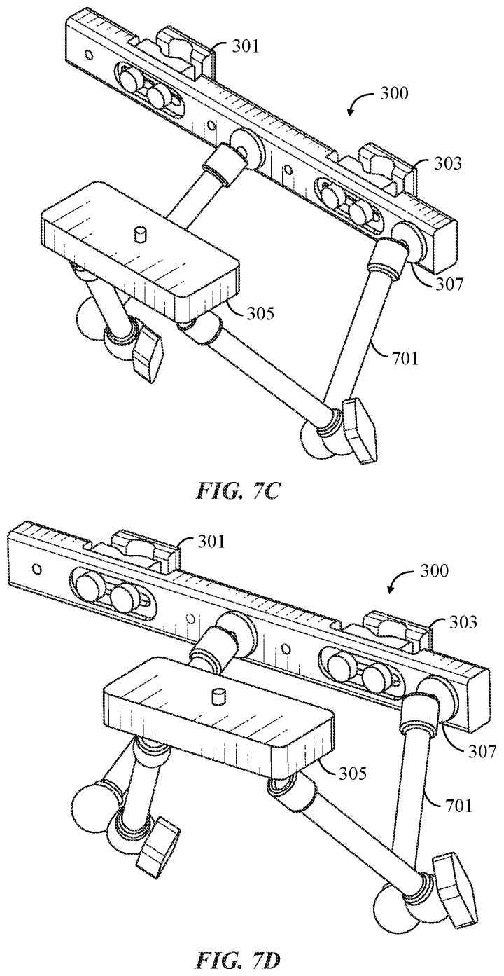

In reference to FIG. 6, a microprocessor 602 is configured to receive a selected image from a user and store the selected image within the memory module 603. It is contemplated that the microprocessor 602 is configured to receive a selected image from a user over a wireless network 64 where it can be compared using a comparator 605 with the plurality of store images within the memory module 603. If the selected images are already saved it may enable the user to terminate the download or save the newly selected image. The microprocessor 602 is further pre-programmed to send transmit a selected image within the memory module 603 to the projector 606 where it may be displayed using a lens onto the interior and/or exterior portion of the automobile. A network 607 provides a communication means for the projector system. A user may operate a computing device to select from a plurality of imagery options to be projected onto the vehicle. Preferably, the projector is connected to controller 610 that controls the projector. Preferably, the controller 610 assists a user in selecting and projecting a projected image. Further, the controller 610 provides control of such decorative design characteristics as, for example, color, frequency, placement, indicia, pattern, image, rate of change, etc. The controller preferably comprises multiple controls for controlling more than one laser projector and more than one decorative design characteristic.

In some embodiments, the apparatus 10 is releasably attached to a rear-view mirror of vehicle. The projector may be a digital, laser, Liquid Crystal Display, or a hybrid of lasers and Light Emitting Diodes (LED) and includes an adjustable lens which provides for a standard, wide, or ultra-wide display. The projector may employ keystone correction in order to adjust the linearity of the image when projected non-orthogonally to the window and to compensate for curvature of the window.

The apparatus 10 projects the imagery onto the glass portion of the automobile. The projector may further include a timer to display the selected image for a pre-determined period of time. For example, the apparatus 10 may be releasably attached to a taxicab, ride-sharing vehicle, or tractor trailer and display a variety of business logos as it transits within a city or highway. The logos may include but are not limited to professional and collegiate sports, business names, social media trends, advertisements, and/or major news events.

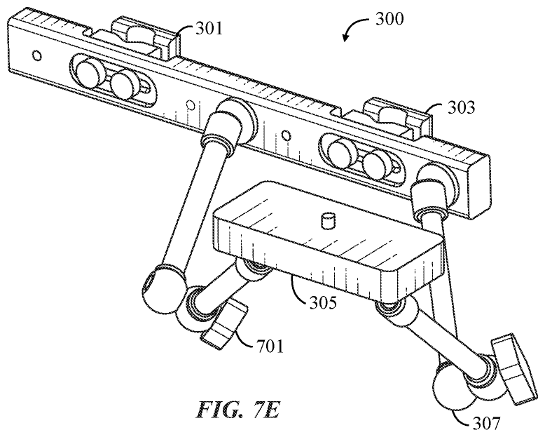

FIGS. 7A-7E illustrate the mounting assembly 300 including the first bracket 301 and a second bracket 303 to releasably engage the mounting assembly 300 to a surface within the interior of the vehicle. As illustrated in the various figures, mount 305 releasably engages with the projector apparatus permitting tilting and rotation of the apparatus 10 via a plurality of pivots 307 pivot arms 701 to allow for the movement of the projector once mounted to the mounting assembly 300. The mount 305 may sliding engage with a member to permit the movement of the apparatus along the length of the member. One skilled in the arts will readily understand that various amounts, sizes, and configurations of pivot arms 701, pivots 307 and the like may be implemented.

The apparatus works with systems and methods for delivering advertisements. The apparatus either is connected directly to the internet via LTE or 5G, and can also connect via Bluetooth or WiFi to the smartphone of a driver, which is running software to communicate with the apparatus. The smartphone or the apparatus has a GPS or geolocation capability so that it knows at any time where it is. It uploads its location and what advertisements it is showing at any time to the cloud service. When the vehicle starts driving, the cloud is notified that another advertising node is online. If the user navigates somewhere, the system notes how long the ride will be by communicating with the user's phone navi (the app integrates with the navi app of the phone) or communicates with the car to find out how long the ride it. Or it uses historical data to determine the length of the ride. Based on location, it determines if it is a city ride or a freeway ride and the speed of the vehicle. It provides real-time information to the cloud thus about “ad avails”, i.e. location and time slots and speed that the ads are to be delivered at. Based on traffic measurements in that area (real time), zip code, and other demographic lookups, it determines an exposure rate (slow traffic on a freeway might provide massive exposure, as drivers are just looking around; vs. high speed lightly populated freeway, vs. slow traffic on surface streets with lots of red lights). This is compiled into an exposure and estimated viewer density rating. It can include what lane the driver is in. IT can include if the driver is an uber/lyft driver, whether the ad is seen by the passenger. Ads can be designed to be usable in both directions, if text is only right side viewable on outside, logo and call to action still visible inside.

In embodiments, drivers in an uber or lyft are integrated so that if they see the advertisement while being a passenger, there is a call to action within the lyft/uber app they are running to click the product or service advertised. There may also be if they ask the driver about it, an action in the driver's app where they can purchase or register for the product or service. Given that the driver may have their contact info already due to the ride sharing app (either directly or indirectly and anonymously during that driver, through a service), the driver can send them a link via the app or from our app to their app, which they can then activate then or later, and the driver can get compensated for the referral and the advertiser can be informed of the successful call to action/real world “click through” of the ad.

In embodiments, the system consists of a cloud service connected to various 3rd party ad servers and connected to 3rd party advertisers, and the system provides deep real-time ad avails based on the real-time information above, including location, and additionally type of vehicle that the ad is running on, so that the situation of the ad (on a prius vs, on a lexus or tesla) can influence the price of the ad. The cloud service then provides these and if not already showing scheduled ads, offers the ads in real time for fulfillment. Existing ad bidding systems can be reconfigured to deal with the unique new signals such as speed of ad (35 vs. 70 mph), location density, etc.

The delivery of the ads can be directly to the projection device or cached on a driver smartphone and then locally beamed to the projection device, or a combination. The projection device may rely on the location information of the smartphone or have its own geolocation through WiFi or GPS or cellular triangulation or visual recognition.

In embodiments, the projection device employs a camera either integrated or separate such as a dashcam facing the passenger, and uses facial recognition to create specific (identify the person) or general (identify the demographics of the person based on age, race, clothing) to create a real-time demographic profile. The projection device may collect demographic information through communication with a cloud service or by extracting this information from a ride sharing application that has been used to book the transportation.

The system uploads all accumulated information about the demographics of the person to whom the ad is being delivered, either on an intimate passenger basis or on a broader basis of who is looking at the system.

In embodiments, a camera is placed looking outward from the advertisement and uses gaze tracking to anonymously or non-anonymously count impressions by determining when passengers, drivers or others around the advertisement have looked at the advertisement and how long they have looked at the advertisement. This information can be uploaded in real-time to the cloud service both for tracking after ad delivery as well as in advance, to dynamically adjust the auction price of the ad avail at that moment (based on how many people are looking at the advertising vehicle at a given time). The demographics of the people looking at the vehicle ad can be determined through the same anonymous or non-anonymous facial recognition approach mentioned above, and based on this, a demographic score can be calculated and the quality of the impression can be dynamically updated.

In embodiments, in addition to location, the camera can capture the make, model, and year of the vehicles in proximity of the advertising vehicle, and thus create a demographic profile of the surrounding cars that have the capability of seeing the ad (ad impression profile) and this information can be uploaded to the cloud, for real-time ad avail re-pricing, or to report the types of impressions the ad is getting.

In embodiments, anonymized (face-blurred) sample photos can be sent when the vehicle changes demographic areas (such as zip codes) or viewing contexts (such as rush hour traffic, city traffic, country empty road, etc) and these sample photos can be used for post-processed ad impression auditing.

A variety of different uses of cameras and microphones facing outward (to see who has looked) and inward (to see passenger impressions and call to action) can be created by capturing video on an ongoing basis and uploading it in real time or in batch, either full video or sped up (by sending only every 10th or 30th frame to send a time lapse) and so the entire path of the advertising session can be provided for additional deeper demographic analysis after the fact. This can be used to improve the system, re-price advertisements, re-price the service, or to determine if a driver is adding sufficient value. Audio captured inside the vehicle can be transcribed, anonymized, and used to detect if the advertisement is being responded to, discussed, or engaged with. The data can be locally analyzed for anonymity or privacy, and the system can record but not retain conversational transcripts until the words in the advertisement are detected, at which time only that portion of the conversation relating to the advertisement would be acted upon, uploaded, or tracked.

In embodiments, ambient audio recorded exterior to the vehicle can be used locally or uploaded into the cloud, and analyzed to additionally determine the environment in which the advertisement is being presented. Audio can be used to analyze the presence of other vehicles and how many and the density of them, as well as the environment in which they are. The audio can be used as an additional input in audits to ensure the audio matches the video and presents an audio profile expected (rural sounds for a rural reported location; city sounds for a city reported location, etc) to prevent or detect user tampering with uploaded ad display data.

In embodiments, the captured video of the system can be used to adjust the amount of compensation given to the driver. Similarly, feedback on the areas that the driver drives, video or not, such as can be calculated with traffic information, can be used to encourage drivers to drive in areas more suited to the types of advertisements that need to be shown.

In embodiments, ride share drivers can be encouraged to take rides in particular areas not just to satisfy demand for passengers, but to improve ad performance. For instance, a driver can be encouraged to take a route that has more passenger foot traffic. The increased results of this “scenic” route can be compensated to the driver to make up for situations where the ride sharing fee would be lower, because the delivery rate of passengers might be reduced in high-traffic areas. Thus, the system can help smooth out the income for a ride sharing driver because slow driving generally results in higher-value impressions.

In embodiments, the cloud system can determine what advertiser profiles are desired and what the balance of ad avails is being provided, so that if there is more demand for a particular demographic or psychographic (affluent/middle-income/urban/rural), drivers can be encouraged. In some cases, the routes performed or suggested by the ride sharing software may be modified to provide additional specific ad avails that are in demand.

In embodiments, a real-time occurrence of an event may require a density of a specific message in a particular area. There may be a concert that needs to increase attendance and wants to buy out ads in an area to create a real-time behavioral change. There may be a public service message or an Amber alert that needs to be rapidly disseminated in an area. The cloud system may receive a request to display such an alert on an immediate basis in all vehicles in a particular zip code or region. Additionally, the system may incentivize drivers to go to a location and display that message. Thus, a driver without a rider may be offered a spot payment to relocate and seek drivers in a different area, or simply to go to that area and display that message. In this way, an advertiser or publicist can rapidly deploy a message into an area by mobilizing a set of projection vehicles.

In embodiments, drivers who are not currently driving but who are registered with the system may receive a message, an email, a push notification, a voice phone call, or text message incentivizing them to go to a location and display the message.

In embodiments, the projector is simply a “dumb” display and an offboard unit in the vehicle, connected to the projector wired or wirelessly, performs the computation and advertisement download and display. The projector may integrate the computing elements. The projector may communicate with an application on a smartphone that performs the computing functions. The projector may communicate directly to a cloud service that performs the computing functions. The projector may communicate through a wireless hotspot or an application on a smartphone, directly to a cloud service that performs the functions.

The projection system may be equipped with anti-tampering software to ensure that the actual image presented has not been altered by the driver or someone with physical access to the projection system. The software may be on the projector, a separate unit, a smartphone, or the cloud. The software may perform audits of the displayed images and retrieve information from the projector that has been sampled separately from the function of the software, to assure ensure that no tampering is occurring between the software and the projector unit.

The projection system may upload samples of what is displayed to a 3rd party cloud service, independent of the advertising cloud system, for independent audit of the delivery of advertisements. These samples comprise a combination of the location where the ad is to be delivered, pictures of the environment concurrent with its delivery, the IP addresses and geolocation data of the devices in the environment when it was delivered, the devices including any phones or wife hotspots or the projector itself; the zip code, and street address or freeway location where it was delivered; the approximate density of population; an estimate of how many people could have seen the ad; an estimate of how many people did see the ad, audio and video and still images of the interior and exterior of the vehicle before, during and after the delivery of the advertisement. This data can be used to independently verify the effectiveness and authenticity of the advertising data reported, and thus be used to verify any ad-revenue sharing payments made to drivers and to charge the correct amount to advertisers.

In embodiments, the software creating the image for the projector can integrate an additional keystoning option. The software can distort, warp, alter, or change the corners of the image, alter the projection of the image to fit a different shaped (such as trapezoidal, parallelogram, or other quadrilaterally shaped window projection surfaces in a vehicle. The driver may use software running on a smartphone to point at the image and the software will take a picture, compare the projection to the source image, and create a matrix distortion that can be applied to morph the image on the glass back to the correct aspect ratio and remove distortions caused by nonlinear and non-orthogonal projection (such as the projector being off-axis with the window) as well as to compensate for the curvature of the window. The software may also be used to note the location of the film on the window and ensure that the image maximizes the surface area of the reflective film but does not spill over the edge of it. The matrix operations needed to adjust for distortion are then provided to the software feeding the advertisements or images to the projector system, or to the projector itself.

In embodiments the film has multiple lines of gradation or lensing, such that it can capture projected images and show one to the outside while reflecting a different image to the inside. Alternate scan lines of the image are projected inward and outward. The software can project the same image interlaced, so that alternate scan lines project the image outward for outside viewers and the same or a different image for the inside viewers. In this way, the passenger can see an ad with the text in the correct direction for viewing.

In embodiments, the projector can operate in an offline mode for a long period of time, displaying advertisements or images with only a time stamp. This data can be periodically or dynamically retrieved by physically or wirelessly downloading it to an application, which then correlates the time stamp of the display with the location of the phone presumed or verified to be in that vehicle at that time, in order to reconstruct a series of locations and impressions, which can then be provided to the cloud service and any payment for ads displayed or charges for licensed images displayed can be reconciled after the fact.

In embodiments, the projector can display the advertisements on the side rear windows, the front passenger or driver windows, or portions of the rear windshield.

In embodiments, the advertising or image display projection system automatically disables the projection image in geographic areas where such images are not permitted to be shown, or during times or in locations where for policy, privacy, personal or commercial reasons, the images should not be shown.

In embodiments, the system can be configured to show specific images in specific locations, superseding any advertisements that would be shown. For instance, around a stadium or park or in a rival area, sports logos could be shown to demonstrate team pride.

In embodiments, an audio track synchronized with the advertisement may be played on the smartphone of a ride sharing driver, and thus through the speakers of the vehicle, to provide audio-visual ads to people in the vehicle. Similarly, the audio may be configured to be output to a speaker on the outside of the vehicle, separate from or attached to an optional external projection system, to be heard by people outside of a vehicle.

In embodiments, the command to display a synchronized set of images could be received external to the vehicle over a WiFi, civic wireless system, 4G or 5G connection, or other RF signaling system. The civic or outdoor commercial infrastructure may have a set of speakers that provide ambient sound to people in the area. The projector system receives timecode from the system, synchronizes with the time code, and then projects moving video on the car that is synchronized with the audio playing on the loudspeakers in the environment. This would be beneficial in environments such as the Las Vegas strip, etc where environmental audio can be combined with large numbers of synchronized video streams.

In embodiments, the projector system uses audio recognition such as Shazam or voice recognition/transcription to determine what the passenger is speaking about or listening to, and then provides visual information, advertisements, or entertainment appropriate to and related to the interests of the passengers. The projector can listen to the radio and determine what is being played. Internal cameras can determine the level of attention or engagement of the passenger in the environment or personal activity and display video as appropriate.

In embodiments, instead of a projector, the system uses an LCD, LED, OLED or other translucent self-lit display screen. Instead of the normal backlight and opaque backing, the naturally translucent aspect of screens is taken advantage of. The screen is positioned in front of the rear passenger window, and does not require a projection system. The user can see through the screen to the environment outside.

In embodiments, the projector is a short-throw projector, where the distance between the projector and the window is 1-6 inches. The projector is placed above the window, attached to the ceiling of the area near the door it is projecting to. In this way, it is unobtrusive to the passenger. In such a configuration, multiple such projectors could be installed, one for each display window desired in the vehicle.

In embodiments, a van or other coach configured vehicle is equipped with windows oriented so that a conventional LCD panel (such as a 65″ screen) or groups of panels, tiled, of such displays can be displayed to the outside of the vehicle.

In embodiments, the advertising system is integrated with fleet management software. The fleet manager is able to configure the arrangement and configuration of ad avails, and provide them on a bulk aggregated basis to an advertising marketplace. The system provides the fleet manager with the ability to provision their full number (say, hundreds or thousands) of vehicles with the specifics of each vehicle. The full fleet can be inserted into a marketplace, and advertisers can bid on “buying out” the entire fleet and negotiate direct pricing with that manager, with the system acting as a broker and taking a portion of the advertisements sold.

In embodiments, a holographic projection on the surface of the vehicle can be used for display of 3-dimensional volumetric advertisement. A substrate, a container of a projection medium on the roof of the vehicle, a spinning screen, or any known or future system for displaying volumetric stills and animations can be placed on the vehicle, powered by the vehicles' power, and provided images by the projection system.

In embodiments, special headrests with integrated projection, designed for specific models of vehicles, can be installed. For instance, a headrest for a Prius or Crown Victoria can be custom-shaped with the projection system embedded within it. Power, signal, antenna, and video for the projector can be fed on a cord integrated with the seat, as with traditional in-headrest screens, but where the headrest screen is replaced with a projection system. The projection system may integrate a screen as well, so that the passenger sees the ad on the screen, but the screen also includes a projector putting an image on the window.

In embodiments, existing taxi screen/advertising systems can be upgraded with an attached projector or replaced with an integrated projector, so that existing workflows of in-vehicle advertisement delivery and payment can be augmented with vehicle-exterior ads. The ads on the interior and exterior of the vehicle need not be the same.

Passenger-side projectors can be used to present the name or identifying details relevant to ride-sharing. The projector system and application can integrate with ride sharing systems to provide additional identification making it quicker for riders to identify the correct vehicle. Similarly, the projection system can be used to identify when a fleet vehicle, taxi, or other transportation vehicle is in or out of service.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A mobile projection apparatus, comprising:
a hermetically sealed housing to retain a projector, the hermetically sealed housing configured to be releasably attached to a vehicle;
a microprocessor including a memory module and configured to receive a plurality of projectable images over a wireless network, the memory module configured to store a plurality of imagery to permit a user to selectively display the imagery on a film provided on the interior surface of the vehicle.

2. The apparatus of claim 1, wherein the housing comprises a translucent portion to project the imagery onto an exterior surface of the vehicle.

3. The apparatus of claim 1, wherein the housing is releasably engaged to a mounting assembly configured to releasably engage with the interior of the vehicle.

4. The apparatus of claim 3, wherein the mounting assembly releasably engages to the vehicle via a first bracket and a second bracket.

5. The apparatus of claim 4, wherein the mounting assembly further comprises a pivot to permit the rotation of the projector.

6. The apparatus of claim 1, further including an adjustable projector lens to provide at a standard, wide, and ultra-wide angle projection of the selected image.

7. The apparatus of claim 1, wherein the projector further includes a plurality of light emitting diodes.

8. The apparatus of claim 1, wherein the microprocessor is configured to receive a selected image over a wireless network.

9. The apparatus of claim 8, wherein the microprocessor is further configured to transmit a selected image from the memory module to the projector.

10. A mobile projection apparatus to display a plurality of logos and messages ono an exterior portion of a vehicle, the apparatus comprising:
a hermetically sealed housing having a translucent portion to enable projected images to be visible onto a portion of a vehicle, the housing releasable mounted to the vehicle via a mounting assembly.
a microprocessor configured to receive at least one selected image over a wireless network and compare with a plurality of stored images within a memory module to store an at least one selected image within the plurality of stored images and selectively transmit to a display module configured to receive a selected image from the plurality of stored images and transmit the image for a pre-determined period of time onto the exterior portion of the vehicle.

11. The apparatus of claim 10, wherein the mounting assembly releasably engages to the vehicle via a first bracket and a second bracket.

12. The apparatus of claim 11, wherein the mounting assembly further comprises a pivot to permit the rotation of the projector.

13. The apparatus of claim 12, further including an adjustable projector lens to provide at a standard, wide, and ultra-wide-angle projection of the selected image.

14. The apparatus of claim 13, wherein the projector further includes a plurality of light emitting diodes.

15. The apparatus of claim 14, wherein the microprocessor is configured to receive a selected image over a wireless network.

16. The apparatus of claim 16, wherein the microprocessor is further configured to transmit a selected image from the memory module to the projector.

17. The apparatus of claim 16, further comprising a controller to permit a user to select the image.

18. The apparatus of claim 17, wherein the mounting assembly permits the sliding engagement of the mount.

19. The apparatus of claim 18, wherein the plurality of stored images within the memory module include: athletic teams, business names, social media feeds, and news events.

20. A mobile projection apparatus to display a plurality of logos and messages ono an exterior portion of a vehicle, the apparatus comprising:
a hermetically sealed housing having a translucent portion to enable projected images to be visible onto a portion of a vehicle, the housing releasable mounted to the vehicle via a mounting assembly comprising a mount sliding engaged with a member, wherein the member is rotationally engaged with the mount via a pivot.
a microprocessor configured to receive at least one selected image over a wireless network and compare with a plurality of stored images within a memory module to store an at least one selected image within the plurality of stored images and selectively transmit to a display module configured to receive a selected image from the plurality of stored images and transmit the image for a pre-determined period of time onto the exterior portion of the vehicle.
